(19) United States
(12) Patent Application Publication
(10) Pub. No.: US 2025/0069231 A1
(43) Pub. Date: Feb. 27, 2025

(54) IMAGE SEGMENTATION APPARATUS, IMAGE SEGMENTATION METHOD, AND RECORDING MEDIUM

(71) Applicant: CANON MEDICAL SYSTEMS CORPORATION, Otawara-shi (JP)

(72) Inventors: Xiao XUE, Beijing (CN); Gengwan LI, Beijing (CN); Bing HAN, Beijing (CN); Bing LI, Beijing (CN)

(73) Assignee: CANON MEDICAL SYSTEMS CORPORATION, Otawara-shi (JP)

(21) Appl. No.: 18/814,456

(22) Filed: Aug. 23, 2024

(30) Foreign Application Priority Data
Aug. 24, 2023 (CN) 202311071097.0
Aug. 7, 2024 (JP) 2024-130607

(51) Int. Cl. G06T 7/11

(52) U.S. Cl. CPC G06T 7/11

(57) ABSTRACT

An image segmentation apparatus according to an embodiment of the present disclosure includes processing circuitry. The processing circuitry is configured to obtain a massive region to which labeling information is attached and a tubular region to which labeling information is attached. By using the labeling information of the massive region and the labeling information of the tubular region, the processing circuitry is configured to generate a region to be segmented and a non-boundary region, by carrying out a distance transformation. The processing circuitry is configured to generate a classifier for classifying spatial coordinates, by using the labeling information of the non-boundary region and labeling information in a specific position determined on the basis of the region to be segmented and the tubular region. The processing circuitry is configured to segment voxels in the region to be segmented by using the classifier and to thus determine a final segmentation result.

### CROSS-REFERENCE TO RELATED APPLICATIONS

This application is based upon and claims the benefit of priority from Chinese Patent Application No. 202311071097.0, filed on Aug. 24, 2023; and Japanese Patent Application No. 2024-130607, filed on Aug. 7, 2024, the entire contents of all of which are incorporated herein by reference.

### FIELD

Embodiments described herein relate generally to an image segmentation apparatus, an image segmentation method, and a recording medium.

### BACKGROUND

When diagnosing a disease, to determine the position of the seat of the disease is an important process in establishing a treatment plan. In an example of the lungs, segmenting the lungs into pulmonary lobes and pulmonary segments is important for determining the position of the seat of a disease.

In relation to the above, a technique has conventionally been proposed by which the pulmonary segments are segmented on the basis of the distance from unlabeled regions in the pulmonary lobes to a labeled region (the trachea, a blood vessel, etc.). However, a segmentation result from the conventional technique exhibits a small sawtooth pattern at boundaries, which will impact observations of medical doctors.

Further, another technique has also conventionally been proposed by which pulmonary segments are segmented by carrying out curve fitting according to feature points at a boundary of a lung region labeled by a user. However, this labeling method is not intuitive and does not directly use information of the trachea or a blood vessel. Thus, the user is required to check the pulmonary segments on the basis of a generated curved plane. Further, because labeling positions may vary among medical doctors (users), there is a possibility that results may greatly vary.

### BRIEF DESCRIPTION OF THE DRAWINGS

FIG. 1 is a block diagram illustrating an exemplary configuration of an image segmentation apparatus according to a first embodiment;

FIG. 2A is a drawing illustrating an example of an image of a pulmonary lobe region to which labeling information is attached;

FIG. 2B is a drawing illustrating an example of an image of a trachea region to which labeling information is attached;

FIG. 3 is a flowchart illustrating a process (an image segmentation method) performed by the image segmentation apparatus according to the first embodiment;

FIG. 4 is a drawing illustrating a scheme for generating a boundary region and a non-boundary region (a coarse segmentation result);

FIG. 5 is a flowchart illustrating details of a process (step S103) for generating a classifier by using labeling information;

FIG. 6 is a drawing indicating a process of uniformly sampling the coarse segmentation result;

FIG. 7 is a drawing indicating a scheme for generating specific positions to which labeling information is attached;

FIG. 8 is a drawing indicating a process of generating a classifier by using a first input and a second input;

FIG. 9 is a drawing illustrating a final segmentation result obtained from the first embodiment and a segmentation result obtained from a comparison example presented for comparison;

FIG. 10 a block diagram illustrating an exemplary configuration of an image segmentation apparatus according to a second embodiment;

FIG. 11 is a flowchart illustrating a process (an image segmentation method) performed by the image segmentation apparatus according to the second embodiment; and

FIG. 12 is a drawing for comparing before and after a correction based on experience labeling, after the experience labeling is applied to a result of fine segmentation.

### DETAILED DESCRIPTION

An image segmentation apparatus according to an embodiment of the present disclosure includes processing circuitry. The processing circuitry is configured to obtain a massive region to which labeling information is attached and a tubular region to which labeling information is attached. The processing circuitry is configured to generate, by using the labeling information of the massive region and the labeling information of the tubular region, a region to be segmented to which no labeling information is attached and which is a boundary region of substructures of the massive region and a non-boundary region serving as a coarse segmentation result to which labeling information is attached, by carrying out a distance transformation. The processing circuitry is configured to generate a classifier for classifying spatial coordinates, by using the labeling information of the non-boundary region and labeling information in a specific position determined on a basis of the region to be segmented and the tubular region. The processing circuitry is configured to segment voxels in the region to be segmented by using the classifier and to thus determine a final segmentation result.

Exemplary embodiments of an image segmentation apparatus, an image segmentation method, and a recording medium will be explained below, with reference to the accompanying drawings. The following embodiments are not intended to limit the present disclosure. Further, in the following description, some of the constituent elements having substantially the same functions or configurations will be referred to by using the same drawing reference characters, and explanations will be repeated only when necessary. Further, among different drawings, some of the constituent elements that are the same may be explained by using different expressions.

As generally known, because the lungs, the trachea, and blood vessels in the human body have apparent physical boundaries, segmentation has a low degree of difficulty. It is therefore possible to have these elements manually labeled by a medical doctor or to have these elements automatically labeled by machine learning. However, in order to determine the position of the seat of a disease, it may be necessary, in some situations, to further segment the lungs into substructures (pulmonary segments) of a plurality of segments, on the basis of supply information of the trachea and the blood vessels. As for the pulmonary lobes serving as an outer layer structure covering the trachea and the blood vessels, because there are no apparent physical boundaries inside, it is difficult to segment the pulmonary lobes into substructures (pulmonary segments) of a plurality of segments.

To cope with this situation, the present embodiments provide an image segmentation apparatus and an image segmentation method. By using the image segmentation apparatus, it is possible to obtain a smooth boundary segmentation result, to provide labeling information that is intuitive and makes identification easier for medical doctors, and to enhance a level of precision of the segmentation.

### First Embodiment

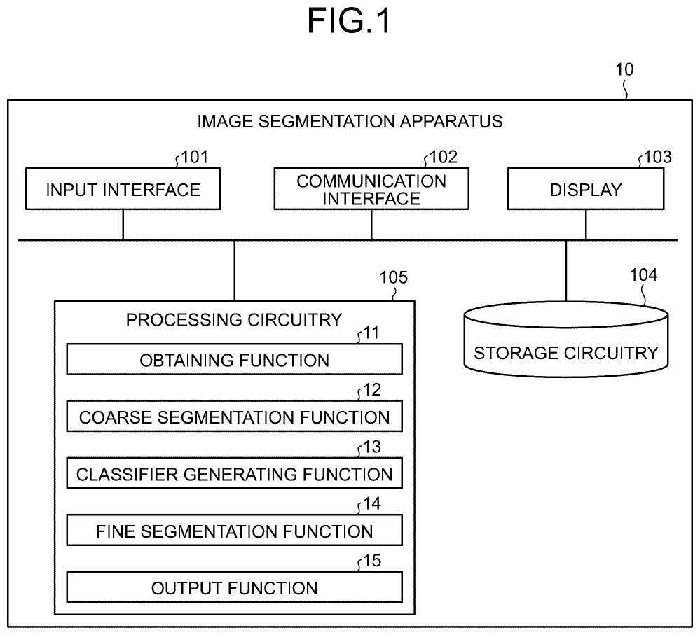

FIG. 1 is a block diagram illustrating an exemplary configuration of an image segmentation apparatus 10 according to a first embodiment. As illustrated in FIG. 1, the image segmentation apparatus 10 according to the present embodiment includes an input interface 101, a communication interface 102, a display 103, processing circuitry 105, and storage circuitry 104.

The input interface 101 is realized by using a trackball, a switch button, a mouse, a keyboard, a touchpad on which input operations can be performed by touching an operation surface thereof, a touch screen in which a display screen and a touchpad are integrally formed, contactless input circuitry using an optical sensor, audio input circuitry, and/or the like, which are used for establishing various settings and the like. The input interface 101 is connected to the processing circuitry 105 and is configured to convert input operations received from an operator into electrical signals and to output the electrical signals to the processing circuitry 105. Although the input interface 101 is provided inside the image segmentation apparatus 10 in FIG. 1, the input interface 101 may be provided on the outside thereof.

The display 103 is connected to the processing circuitry 105 and is configured to display various types of information and various types of image data output from the processing circuitry 105. For example, the display 103 is realized by using a liquid crystal monitor, a Cathode Ray Tube (CRT) monitor, a touch panel, or the like. For example, the display 103 is configured to display a Graphical User Interface (GUI) used for receiving instructions from the operator, various types of display images, and various types of processing results obtained by the processing circuitry 105. The display 103 is an example of a display unit. Although the display 103 is provided inside the image segmentation apparatus 10 in FIG. 1, the display 103 may be provided on the outside thereof.

The communication interface 102 may be a Network Interface Card (NIC) or the like and is configured to perform communication with other apparatuses. For example, the communication interface 102 is connected to the processing circuitry 105 and is configured to acquire image data from an ultrasound diagnosis apparatus being an ultrasound system and other modalities besides the ultrasound system such as an X-ray Computed Tomography (CT) apparatus, a Magnetic Resonance Imaging (MRI) apparatus, and the like and to output the acquired image data to the processing circuitry 105.

The storage circuitry 104 is connected to the processing circuitry 105 and is configured to store therein various types of data. More specifically, the storage circuitry 104 is configured to store therein at least various types of medical images for image registration and fusion images obtained after the registration, and the like. For example, the storage circuitry 104 is realized by using a semiconductor memory element such as a Random Access Memory (RAM) or a flash memory, a hard disk, an optical disk, or the like. Further, the storage circuitry 104 is configured to store therein programs corresponding to processing functions executed by the processing circuitry 105. Although the storage circuitry 104 is provided inside the image segmentation apparatus 10 in FIG. 1, the storage circuitry 104 may be provided on the outside thereof.

The processing circuitry 105 is configured to control constituent elements included in the image segmentation apparatus 10, in accordance with the input operations received from the operator via the input interface 101.

For example, the processing circuitry 105 is realized by using one or more processors. As illustrated in FIG. 1, the processing circuitry 105 includes an obtaining function 11, a coarse segmentation function 12, a classifier generating function 13, a fine segmentation function 14, and an output function 15. In this situation, the processing functions executed by the constituent elements of the processing circuitry 105 illustrated in FIG. 1, namely, the obtaining function 11, the coarse segmentation function 12, the classifier generating function 13, the fine segmentation function 14, and the output function 15, are, for example, recorded in the storage circuitry 104 of the image segmentation apparatus 10 in the form of computer-executable programs. The processing circuitry 105 is a processor configured to realize the processing functions corresponding to the programs, by reading and executing the programs from the storage circuitry 104. In other words, the processing circuitry 105 that has read the programs has the functions illustrated within the processing circuitry 105 in FIG. 1.

The term “processor” used in the above explanation denotes, for example, a Central Processing Unit (CPU), a Graphics Processing Unit (GPU), or circuitry such as an Application Specific Integrated Circuit (ASIC) or a programmable logic device (e.g., a Simple Programmable Logic Device (SPLD), a Complex Programmable Logic Device (CPLD), or a Field Programmable Gate Array (FPGA)). When the processor is a CPU, for example, the processor is configured to realize the functions by reading and executing the programs saved in the storage circuitry 104. In contrast, when the processor is an ASIC, instead of having the programs saved in the storage circuitry 104, the programs are directly incorporated in the circuitry of the processor. Further, the processors of the present embodiment do not each necessarily need to be structured as a single piece of circuitry. It is also acceptable to structure one processor by combining together a plurality of pieces of independent circuitry so as to realize the functions thereof. Further, it is also acceptable to integrate two or more of the constituent elements illustrated in FIG. 1 into one processor so as to realize the functions thereof.

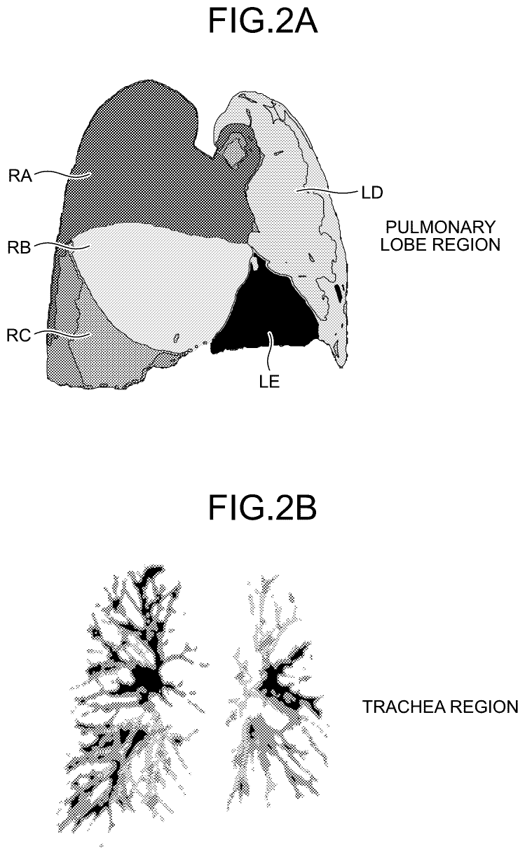

Next, processes performed by the obtaining function 11, the coarse segmentation function 12, the classifier generating function 13, the fine segmentation function 14, and the output function 15 will be explained with reference to FIGS. 2A and 2B. FIG. 2A is a drawing illustrating an example of an image of a pulmonary lobe region to which labeling information is attached. FIG. 2B is a drawing illustrating an example of an image of a trachea region to which labeling information is attached.

The obtaining function 11 is configured to obtain, from a medical image, a massive region to which labeling information is attached and a tubular region to which labeling information is attached. In this situation, the obtaining function 11 is an example of an “obtaining unit”.

The massive region is a region that is anatomically able to cover the tubular region. In an example of the lungs, the massive region may be the pulmonary lobes, for instance, while the tubular region may be the trachea and/or blood vessels, for instance. In the present embodiment, the trachea will be explained as an example; however, blood vessels may be used as the tubular region. In the following sections, the pulmonary lobes may be referred to as a pulmonary lobe region, whereas the trachea may be referred to as a trachea region.

In the present embodiment, the pulmonary lobe region is divided into segments in a first quantity so that mutually-different pieces of labeling information are attached to the segments serving as independent labeled regions. Further, the trachea region is divided into segments in a second quantity so that mutually-different pieces of labeling information are attached to the segments serving as independent labeled regions.

Each of the labeled regions mentioned above can be construed as a set of voxels having mutually the same piece of labeling information. For example, when “RA” is attached to all the voxels in the pulmonary lobe region, it is possible to express the region as an “RA labeled region”. When “r1” is attached to all the voxels in a pulmonary segment, it is possible to express the pulmonary segment as an “r1 labeled region”.

More specifically, in the massive region, generally speaking, the lungs include the left lung and the right lung, while the left lung and the right lung are divided by interlobar fissures having apparent physical boundaries, into five pulmonary lobes (pulmonary segments) as the abovementioned segments in the first quantity. In the present example, among the five pulmonary lobes, the left lung has two pulmonary lobes, whereas the right lung has three pulmonary lobes. In the present embodiment, the massive region to which the labeling information is attached is represented by five labeled regions obtained by attaching mutually-different pieces of labeling information to the five pulmonary lobes. For example, in the pulmonary lobe region illustrated in FIG. 2A, among the three pulmonary lobes of the right lung, the labeling information “RA” is attached to the voxels belonging to the first right segment pulmonary lobe (the upper lobe of the right lung); the labeling information “RB” is attached to the voxels belonging to the second right segment pulmonary lobe (the middle lobe of the right lung); and the labeling information “RC” is attached to the voxels belonging to the third right segment pulmonary lobe (the lower lobe of the right lung). Further, between the two pulmonary lobes of the left lung, the labeling information “LD” is attached to the voxels belonging to the first left segment pulmonary lobe (the upper lobe of the left lung); and the labeling information “LE” is attached to the voxels belonging to the second left segment pulmonary lobe (the lower lobe of the left lung). Further, in FIG. 2A, labeling in mutually the same color is attached to the voxels having mutually the same labeling, for the sake of convenience in observation. This arrangement makes it possible for the user to intuitively distinguish the mutually-different pulmonary segments from one another according to the colors.

Further, in the tubular region, the trachea is divided, in accordance with a supply relationship, into eighteen segments as the abovementioned segments in the second quantity. In the present embodiment, the tubular region to which the labeling information is attached is represented by eighteen labeled regions obtained by attaching mutually-different pieces of labeling information to the eighteen segments. For example, in the trachea region illustrated in FIG. 2B, among the eighteen segments, the pieces of labeling information “11” to “18” are attached to the part of the trachea belonging to the eight segments on the left side, whereas the pieces of labeling information “r1” to “r10” are attached to the part of the trachea belonging to the ten segments on the right side. In FIG. 2B, the mutually-different pieces of labeling information are expressed only by using colors, and the labeling information using text such as “11” to “18” and “r1” to “r10” is omitted from the drawings.

By using the labeling information of the pulmonary lobes (the pulmonary lobe region illustrated in FIG. 2A) serving as the massive region and the labeling information of the trachea (the trachea region illustrated in FIG. 2B) serving as the tubular region, the coarse segmentation function 12 is configured to generate, by carrying out a distance transformation, a region to be segmented to which no labeling information is attached and a coarse segmentation result to which labeling information is attached. For example, by using the labeling information of the pulmonary lobes and the labeling information of the trachea, the coarse segmentation function 12 is configured to generate, by carrying out the distance transformation, the region to be segmented to which no labeling information is attached and which is a boundary region of the substructures (the pulmonary segments) of the pulmonary lobes; and a non-boundary region serving as the coarse segmentation result to which the labeling information is attached. In this situation, the coarse segmentation function 12 is an example of a “coarse segmentation unit”.

The distance transformation is an existing technique and is an algorithm used for estimating a distance. By using the algorithm, the coarse segmentation function 12 determines, as the region to be segmented, certain voxels among which differences in the distance to two labeled regions that are mutually different and positioned adjacent to each other are smaller than a threshold value. More specifically, by using the algorithm, the coarse segmentation function 12 is configured to calculate the certain voxels among which the differences in the distance to the two labeled regions that are mutually different and positioned adjacent to each other are smaller than the threshold value and to further determine a set of voxels in those positions as the boundary region. Subsequently, the coarse segmentation function 12 is configured to determine the boundary region as the region to be segmented, without keeping the original labeling information in the boundary region (without attaching any labeling information thereto).

After that, the coarse segmentation function 12 is configured to determine the remaining region excluding the boundary region as a non-boundary region with which the original labeling information is kept. More specifically, the non-boundary region being the remaining lung region excluding the boundary region is segmented into a plurality of labeled region corresponding to a branch structure of the trachea, by carrying out a distance transformation. The plurality of labeled regions corresponding to the non-boundary region obtained from the distance transformation serve as the coarse segmentation result of the present embodiment. To the labeled regions of the trachea and in the non-boundary region, corresponding labeling information is attached.

As a result of the distance transformation described above, the remaining lung region is transformed from the five original labeled region into the eighteen labeled regions (11 to 18 and r1 to r10) corresponding to the branch structure of the trachea. Consequently, the non-boundary region generated by the coarse segmentation function 12 is divided into the segments in the second quantity which is “18”, so that the mutually-different pieces of labeling information are attached to the segments serving as independent labeled regions.

The classifier generating function 13 is configured to generate a classifier for classifying spatial coordinates, by using the labeling information in the coarse segmentation result (the labeling information of the non-boundary region) and labeling information in specific positions determined on the basis of the region to be segmented and the tubular region (the trachea). In this situation, the classifier generating function 13 is an example of a “classifier generating unit”.

For example, the classifier is obtained by using a Support Vector Machine (SVM) algorithm according to a conventional technique or the like. A principle thereof is to visualize the classifier as a hyperplane. For example, while using the labeling information in the coarse segmentation result and the labeling information in the specific positions as a first input and a second input, respectively, the hyperplane is generated in such a manner that the voxels of labeling information in a certain classification among the labeling information (11 to 18 and r1 to r10) in the coarse segmentation result and the voxels of the labeling information in the specific positions in the same classification are positioned on the same side of the hyperplane, while the labeling information on the two sides of the hyperplane belong to mutually-different classifications.

As the first input, voxels obtained by uniformly sampling the voxels in the coarse segmentation result are used. In this situation, to the sampled voxels, belonging labeling information is attached after spatial three-dimensional coordinates. For example, to the voxels of the first right segment pulmonary lobe (the upper lobe of the right lung), because the belonging labeling information “r1” is attached, a point set of the voxels can be expressed as {(X₁^{r1}, Y₁^{r1}, Z₁^{r1}), (X₂^{r1}, Y₂^{r1}, Z₂^{r1}), . . . }. As another example, to the voxels of the third right segment pulmonary lobe (the lower lobe of the right lung), because the belonging labeling information “r3” is attached, a point set of the voxels can be expressed as {(X₁^{r1}, Y₁^{r1}, Z₁^{r1}), (X₂^{r1}, Y₂^{r1}, Z₂^{r1}), . . . }.

As the second input, all the voxels in the specific positions are used without being sampled. In this situation, to all the voxels in the specific positions also, belonging labeling information is attached after spatial three-dimensional coordinates. For example, to the voxels of the first right segment pulmonary lobe (the upper lobe of the right lung), because the belonging labeling information “r1” is attached, a point set of the voxels can be expressed as {(X₁^{r1}, Y₁^{r1}, Z₁^{r1}), (X₂^{r1}, Y₂^{r1}, Z₂^{r1}), . . . }. As another example, to the voxels of the third right segment pulmonary lobe (the lower lobe of the right lung), because the belonging labeling information “r3” is attached, a point set of the voxels can be expressed as {(X₁^{r1}, Y₁^{r1}, Z₁^{r1}), (X₂^{r1}, Y₂^{r1}, Z₂^{r1}), . . . }.

The specific positions are positions in which the trachea overlaps with the region to be segmented being the boundary region. Accordingly, a certain part of the trachea that overlaps with the region to be segmented is determined as the specific positions, while the labeling information in those positions within the trachea is determined as the labeling information in the specific positions. The region to be segmented is the set of voxels among which the differences in the distance to two labeled regions that are mutually different and positioned adjacent to each other are smaller than the threshold value. The specific positions are a part of the region to be segmented. Accordingly, the voxels in the specific positions are the voxels among which the differences in the distance to the labeled regions that are mutually different and positioned adjacent to each other are smaller than the threshold value and are therefore important for distinguishing the two adjacently-positioned labeled regions. Consequently, when the voxels in the specific positions are used as an input sample, all the voxels are used without being sampled and without being further processed.

As explained above, the classifier generating function 13 is configured to generate the classifier for classifying spatial coordinates, by uniformly sampling the non-boundary region with respect to each of the mutually-different pieces of labeling information and using the sampled voxels as the first input and further using, without sampling, the labeling information in the specific positions specified on the basis of the region to be segmented and the tubular region (the trachea) to which the labeling information is attached as the second input.

The generated classifier is hyperplanes that classify the voxels on the basis of the spatial three-dimensional position information and the labeling information. More specifically, features that are used in the first input and the second input as the input samples used at the time of generating the classifier (the hyperplanes) are spatial three-dimensional coordinate information and the labeling information. Thus, in the first input and the second input, the spatial three-dimensional coordinate information and the labeling information are related to each other. Consequently, when the spatial coordinates are classified by using such a classifier, by using the spatial three-dimensional coordinate information as an input, it is possible to estimate a classification (labeling information) to which the spatial three-dimensional coordinate information belongs. In other words, by using the voxels in the region to be segmented, which has only the spatial three-dimensional coordinate information, the generated classifier is capable of estimating the labeling information to which the voxels belong.

The fine segmentation function 14 is configured to segment the voxels in the region to be segmented by using the classifier generated by the classifier generating function 13 and to thus determine a final segmentation result. In this situation, the fine segmentation function 14 is an example of a “fine segmentation unit”.

The classifier, i.e., the hyperplanes, is capable of segmenting the region to be segmented to which no labeling information is attached, into the plurality of segments and is capable of estimating the labeling information to which each of the segments belongs, on the basis of the spatial three-dimensional coordinate information of the segment. Accordingly, to all the voxels in the region to be segmented, mutually-different pieces of labeling information are attached by the hyperplanes. In other words, by using the hyperplanes, the fine segmentation function 14 is configured to determine the labeling information of each of the voxels in the region to be segmented, on the basis of the spatial three-dimensional position information of the voxels in the region to be segmented and is configured to obtain the final segmentation result, by putting together the determined labeling information of each of the voxels in the region to be segmented, with the labeling information of the non-boundary region (the coarse segmentation result).

The output function 15 is configured to output the final segmentation result generated by the fine segmentation function 14. For example, by causing the display 103 to display the final segmentation result, the output function 15 is configured to present the user (a medical doctor) with the final segmentation result. In this situation, the output function 15 is an example of an “output unit”.

Further, the output function 15 may cause the display 103 to display the pulmonary lobes to which the labeling information is attached and the trachea to which the labeling information is attached, which were obtained by the obtaining function 11. Also, the output function 15 may cause the display 103 to display the region to be segmented to which no labeling information is attached and the non-boundary region to which the labeling information is attached (the coarse segmentation result) which were generated by the coarse segmentation function 12. Furthermore, the output function 15 may cause the display 103 to display the classifier (the hyperplanes) generated by the classifier generating function 13.

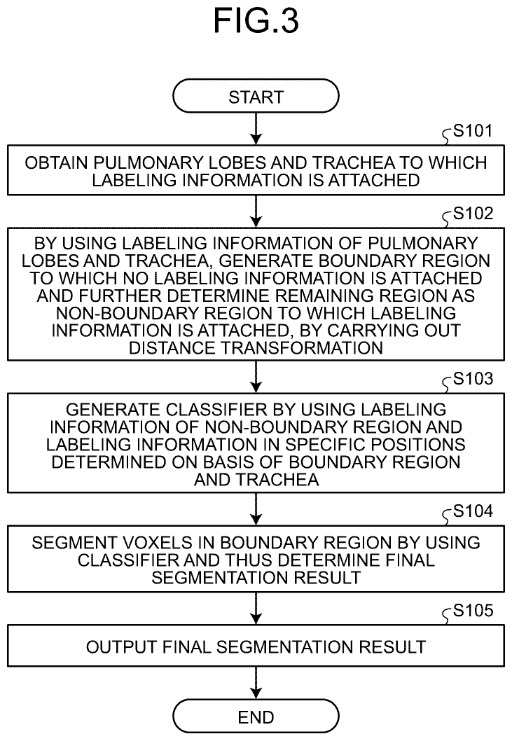

FIG. 3 is a flowchart illustrating the process (the image segmentation method) performed by the image segmentation apparatus 10 according to the first embodiment.

To begin with, at step S101 in FIG. 3, the obtaining function 11 obtains, out of a medical image, the massive region (the pulmonary lobes) and the tubular region (the trachea) to which the labeling information is attached.

Subsequently, at step S102 in FIG. 3, by using the labeling information of the pulmonary lobes and the labeling information of the trachea, the coarse segmentation function 12 generates the boundary region of the pulmonary segments to which no labeling information is attached as the region to be segmented and further generates the non-boundary region (the coarse segmentation result) which is the remaining region excluding the boundary region and to which the labeling information is attached by carrying out the distance transformation.

After that, at step S103 in FIG. 3, the classifier generating function 13 generates the classifier for classifying the spatial coordinates, by using the labeling information of the non-boundary region and the labeling information in the specific positions determined on the basis of the boundary region (the region to be segmented) and the trachea.

Subsequently, at step S104 in FIG. 3, the fine segmentation function 14 segments the voxels in the boundary region by using the classifier and determines the final segmentation result.

Finally, at step S105 in FIG. 3, the output function 15 outputs the obtained final segmentation result.

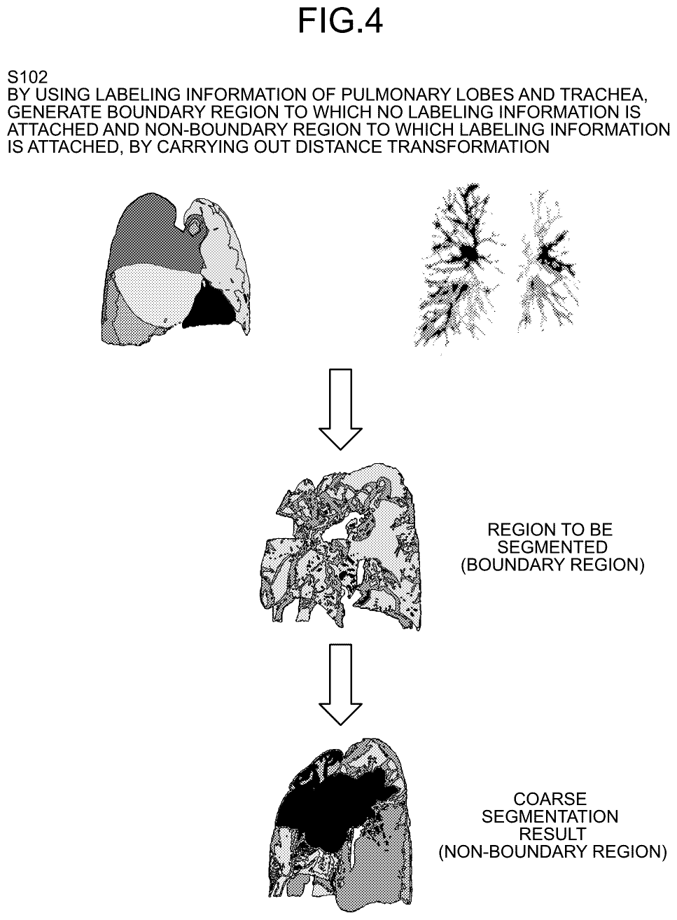

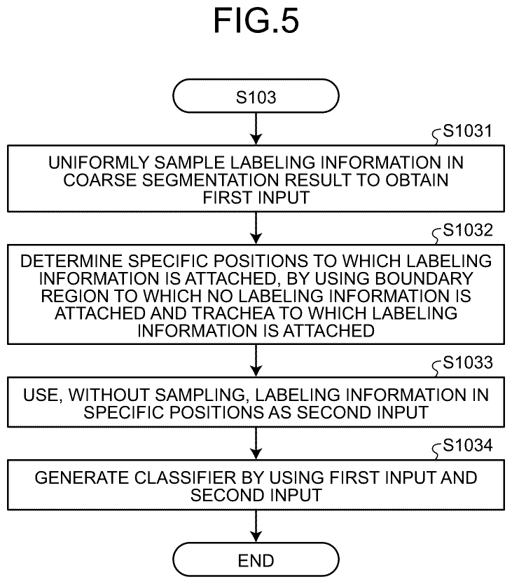

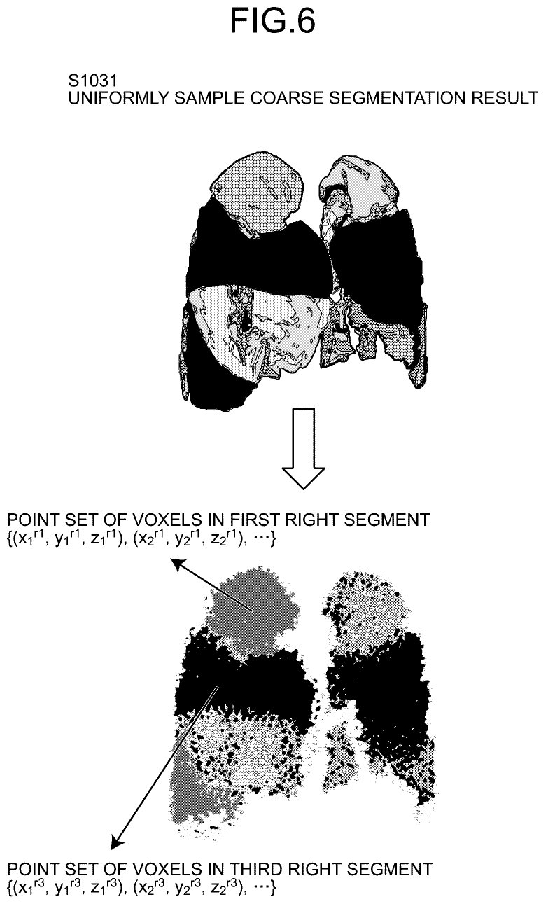

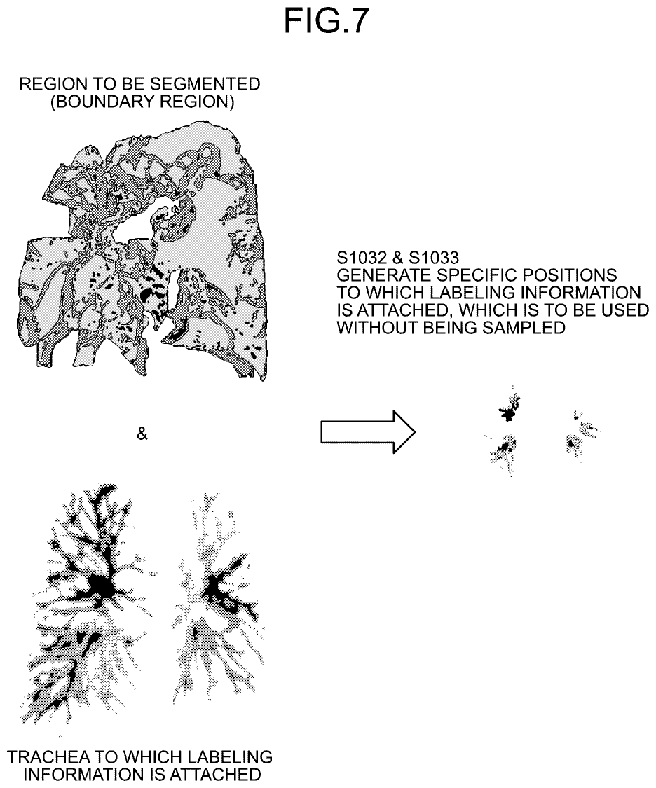

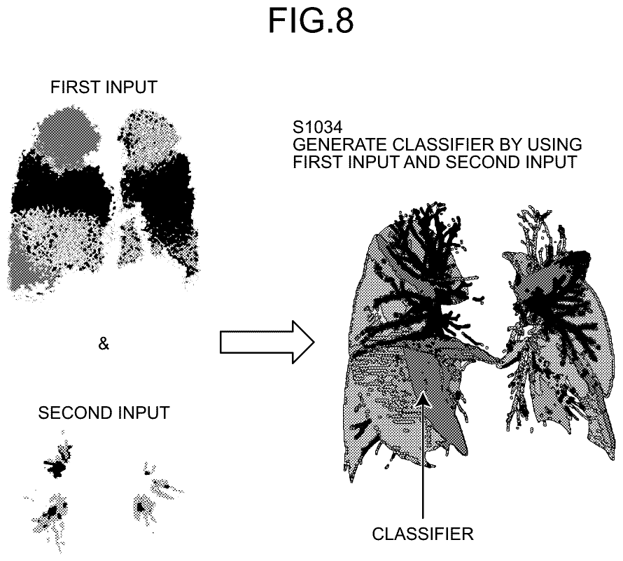

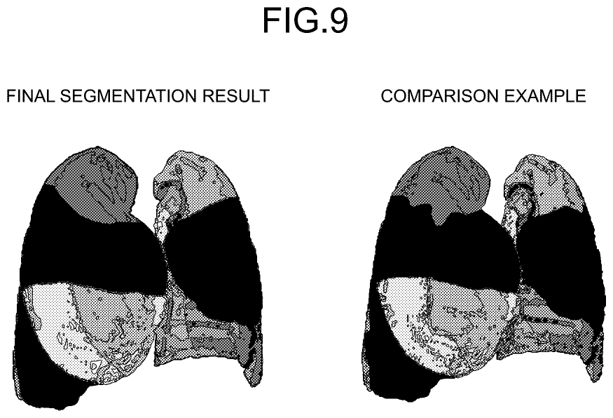

Next, the process (the image segmentation method) performed by the image segmentation apparatus 10 according to the present embodiment will be explained in detail, with reference to FIGS. 4 to 9. FIG. 4 is a drawing illustrating a scheme for generating the boundary region and the non-boundary region (the coarse segmentation result). FIG. 5 is a flowchart illustrating details of the process (step S103) for generating the classifier by using the labeling information. FIG. 6 is a drawing indicating a process of uniformly sampling the coarse segmentation result. FIG. 7 is a drawing indicating a scheme for generating the specific positions to which the labeling information is attached. FIG. 8 is a drawing indicating a process of generating the classifier by using the first input and the second input. FIG. 9 is a drawing illustrating the final segmentation result obtained from the first embodiment and a segmentation result obtained from a comparison example presented for comparison.

At step S101 in FIG. 3, the obtaining function 11 obtains images of the massive region (the pulmonary lobes) and the tubular region (the trachea). In this situation, the pulmonary lobes are divided into the segments in the first quantity being “5”, so that the mutually-different pieces of labeling information are attached to the segments serving as the independent labeled regions. Further, the trachea is divided into the segments in the second quantity being “18”, so that the mutually-different pieces of labeling information are attached to the segments serving as the independent labeled regions. The abovementioned first quantity is “5”, whereas the abovementioned second quantity is “18”. At step S101, as illustrated in the top section of FIG. 4, a pulmonary lobe image having the five types of mutually-different labeling information and a trachea image having the eighteen types of mutually-different labeling information are obtained.

After that, at step S102 in FIG. 3, by using the pulmonary lobe image to which the five types of labeling information are attached and the trachea image to which the eighteen types of labeling information are attached which were obtained at step S101, the coarse segmentation function 12 at first generates, by carrying out the distance transformation, the boundary region of the pulmonary segments as the region to be segmented, as illustrated in the middle section of FIG. 4. More specifically, when differences in the distance from a voxel to two mutually-different substructures (pulmonary segments) is smaller than the predetermined threshold value, it means that the voxel is positioned close to the boundary of the substructures. In this situation, if voxels positioned close to a boundary part were simply segmented by carrying out the distance transformation, the segmentation result would exhibit an evident sawtooth pattern, which would impact observations of medical doctors. To cope with this issue, in the present embodiment, as for the voxels positioned close to the boundary part, the boundary part is kept as the region to be segmented, so that, at step S104 in FIG. 3, the region to be segmented is segmented by the fine segmentation function 14.

Subsequently, by using the pulmonary lobe image to which the five types of labeling information are attached and the trachea image to which the eighteen types of labeling information are attached, the coarse segmentation function 12 generates, by carrying out the distance transformation, the non-boundary region (the coarse segmentation result) being the remaining region excluding the region to be segmented, as illustrated in the bottom section of FIG. 4. The non-boundary region is to be segmented into a plurality of segments in accordance with the branch structure of the trachea which is segmented into a plurality of segments. More specifically, in each of the pulmonary lobes, the pulmonary lobe is divided into a plurality of pulmonary segments on the basis of the supply relationship of the trachea. The five pulmonary lobe regions are divided into the eighteen pulmonary segments in total, i.e., the pulmonary segments having the eighteen types of mutually-different labeling information. Labeling information is attached to the remaining region (i.e., the non-boundary region) excluding the region to be segmented.

After that, the process of the image segmentation apparatus 10 proceeds to step S103 in FIG. 3. The process at step S103 includes steps S1031 through S1034 in FIG. 5. FIG. 5 illustrates the process at steps S1031 through S1034.

At step S1031 in FIG. 5, the classifier generating function 13 uniformly samples the labeling information in the coarse segmentation result and thus obtains the first input.

At step S1032 in FIG. 5, by using the boundary region to which no labeling information is attached and the trachea to which the labeling information is attached, the classifier generating function 13 specifies the specific positions to which the labeling information is attached.

At step S1033 in FIG. 5, the classifier generating function 13 uses, without sampling, the labeling information in the specific positions as the second input.

At step S1034 in FIG. 5, the classifier generating function 13 generates the classifier by using the first input and the second input.

Next, steps S1031 through S1034 will be explained, with reference to FIGS. 6 to 8.

As illustrated in FIG. 6, at step S1031, the classifier generating function 13 uniformly samples the coarse segmentation result (the non-boundary region) to which the labeling information is attached and further classifies the sampled voxels into point sets according to the pulmonary segments to which the voxels belong. As for the voxels belonging to the first right segment pulmonary lobe (the upper lobe of the right lung) illustrated in the top section of FIG. 6, because the belonging labeling information “r1” is attached to the voxels, the point set of the voxels using the spatial three-dimensional coordinates can be expressed as {(X₁^{r1}, Y₁^{r1}, Z₁^{r1}), (X₂^{r1}, Y₂^{r1}, Z₂^{r1}), . . . }. As another example, as for the voxels belonging to the third right segment pulmonary lobe (the lower lobe of the right lung) illustrated in the bottom section of FIG. 6, because the belonging labeling information “r3” is attached to the voxels, the point set of the voxels can be expressed as {(X₁^{r1}, Y₁^{r1}, Z₁^{r1}), (X₂^{r1}, Y₂^{r1}, Z₂^{r1}), . . . }. At step S1031, the classifier generating function 13 uses the abovementioned voxels that were sampled and have the spatial three-dimensional position information and the labeling information, as the abovementioned first input.

As illustrated in the left section of FIG. 7, at step S1032, by using the region to be segmented and the trachea to which the labeling information is attached, the classifier generating function 13 determines the specific positions and the labeling information which the specific positions have. The specific positions are the positions in which the trachea overlaps with the region to be segmented, which is the boundary region. A certain part of the trachea that overlaps with the region to be segmented is determined as the specific positions, whereas the labeling information in such positions within the trachea (i.e., the part overlapping with the region to be segmented) is determined as the labeling information in the specific positions. The voxels in the specific positions are the voxels in the positions among which the differences in the distance to adjacently-positioned labeled regions are smaller than the threshold value and are therefore important for distinguishing the two adjacently-positioned labeled regions. Consequently, when being used as an input sample, those voxels are all used without being sampled and without being further processed. As a result, as illustrated in the right section of FIG. 7, at step S1033, the classifier generating function 13 uses all the voxels in the specific positions which have the spatial three-dimensional position information and the labeling information, as the abovementioned second input.

As illustrated in FIG. 8, at step S1034, by using the first input obtained at step S1031 and the second input obtained at steps S1032 and S1033, the classifier generating function 13 generates the classifier for classifying the spatial coordinates. As the generated classifier, the plurality of hyperplanes illustrated in the right section of FIG. 8 are obtained. With respect to each of the plurality of hyperplanes, labeling information belonging to mutually the same classification are positioned on the same side of the hyperplane, while the labeling information on the two sides of the hyperplane belong to mutually-different classifications. Further, the hyperplanes are determined by the inputs including the spatial three-dimensional position information and the labeling information. As explained herein, the plurality of hyperplanes are present, and with respect to each of the hyperplanes, the voxels positioned on mutually the same side have mutually the same piece of labeling information, whereas the voxels positioned on the mutually-different sides have mutually-different pieces of labeling information. With this configuration, an advantageous effect is achieved where spaces classified by the hyperplanes each correspond to a unique and definitive classification. It should be noted that, although the right section of FIG. 8 also illustrates the trachea segmented by the hyperplanes, the trachea is illustrated for the purpose of indicating an advantageous effect of the hyperplanes and is not a part of the generated classifier.

After that, at step S104 in FIG. 3, by using the hyperplanes, the fine segmentation function 14 determines the labeling information of the voxels in the region to be segmented, on the basis of the spatial three-dimensional position information of the voxels in the region to be segmented and further obtains the final segmentation result, by putting together the labeling information of the voxels in the region to be segmented, with the coarse segmentation result (the non-boundary region to which the labeling information is attached). More specifically, the region to be segmented illustrated in the top section of FIG. 7 is classified by using the generated classifier, so that the region to be segmented is segmented into the pulmonary segments having the eighteen mutually-different pieces of labeling information. The segmentation result of the region to be segmented is put together with the segmentation result of the non-boundary region (i.e., the coarse segmentation result), so as to serve as the final segmentation result.

The left section of FIG. 9 illustrates the final segmentation result obtained by implementing the image segmentation method according to the first embodiment. As illustrated in the drawing in the left section of FIG. 9, the boundary of the abovementioned segmentation result is smooth. In contrast, the right section of FIG. 9 illustrates a final segmentation result obtained by segmenting an image by using only the distance transformation. As illustrated in the drawing in the right section of FIG. 9, a sawtooth pattern is present at the boundaries of the segmented substructures, which would impact observations of medical doctors.

By using the image segmentation apparatus 10 and the image segmentation method according to the present embodiment, it is possible to obtain the segmentation result in which the boundaries are smooth. In addition, in contrast to the method by which a user (an operator) labels feature points at the boundaries so as to carry out the curve fitting, the labeling method of the present embodiment is more intuitive, is capable of providing the labeling information that makes identification easier for medical doctors, and is capable of enhancing the level of precision of the segmentation.

### Second Embodiment

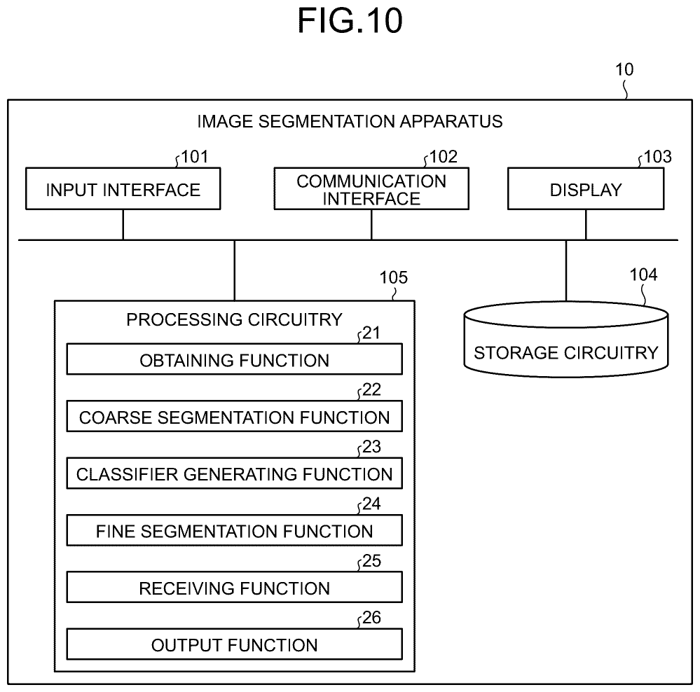

FIG. 10 is a block diagram illustrating an exemplary configuration of an image segmentation apparatus 20 according to a second embodiment. A difference between the second embodiment and the first embodiment lies in that the image segmentation apparatus 20 is configured to prompt the user to input experience labeling, in addition to the constituent elements of the image segmentation apparatus 10 according to the first embodiment.

More specifically, as illustrated in FIG. 10, the processing circuitry 105 of the image segmentation apparatus 20 includes an obtaining function 21, a coarse segmentation function 22, a classifier generating function 23, a fine segmentation function 24, a receiving function 25, and an output function 26.

Because processes performed by the obtaining function 21, the coarse segmentation function 22, the classifier generating function 23, the fine segmentation function 24, and the output function 26 presented above are the same as the processes performed by the obtaining function 11, the coarse segmentation function 12, the classifier generating function 13, the fine segmentation function 14, and the output function 15 according to the first embodiment, duplicated explanations will be omitted. In the following sections, the process of prompting the user to input the experience labeling will primarily be explained.

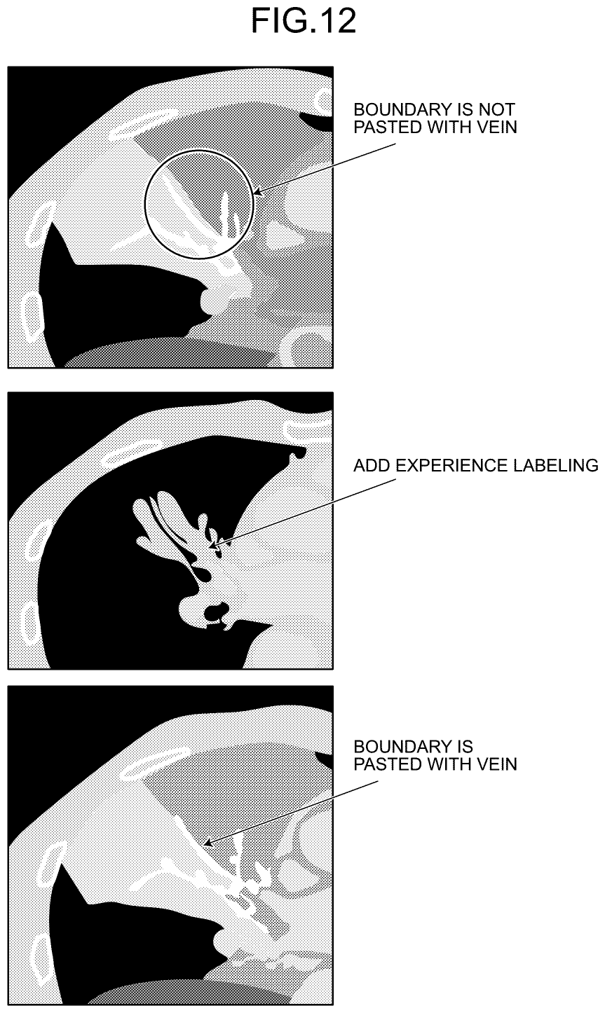

FIG. 12 is a drawing for comparing before and after a correction based on experience labeling, after the experience labeling is applied to the result of the fine segmentation. As illustrated in the top section of FIG. 12, in the final segmentation result obtained from the process (the image segmentation method) performed by the image segmentation apparatus 10 according to the first embodiment, the segmented boundary may not be pasted with a vein, in some situations. In actuality, however, it is desirable to obtain a segmentation result in which the segmented boundary is pasted with the vein. Accordingly, it is necessary to correct the final segmentation result.

For example, the user inputs the experience labeling by using the input interface 101. The receiving function 25 is configured to receive the experience labeling input via the input interface 101. The input interface 101 may be an input interface configured to prompt the user to input the experience labeling. By using the input interface 101, the user is able to artificially increase the experience labeling. In this situation, the input interface 101 is an example of an “input unit”.

The user is able to use the input interface 101 at different stages of the image segmentation. For example, after the fine segmentation function 24 having generated a final segmented image, and the output function 25 having output the final segmented image, the user may employ the input interface 101 so as to add the experience labeling illustrated in the middle section of FIG. 12 to a boundary position that does not fit expectation, so that the classifier generating function 23 uses the additional experience labeling in place of the existing labeling. In this manner, a better segmentation result is obtained. Alternatively, the obtaining function 21 may be configured to obtain the pulmonary lobe image to which the labeling information is attached and the trachea image to which the labeling information is attached and to further obtain the experience labeling via the input interface 101. The experience labeling input via the input interface 101 is to be used for generating a classifier, as the labeling information in the specific positions.

According to the second embodiment, it is possible to add the artificial intervention during the automatic image segmentation process. Thus, by adjusting a small local position, it is possible to realize more accurate segmentation.

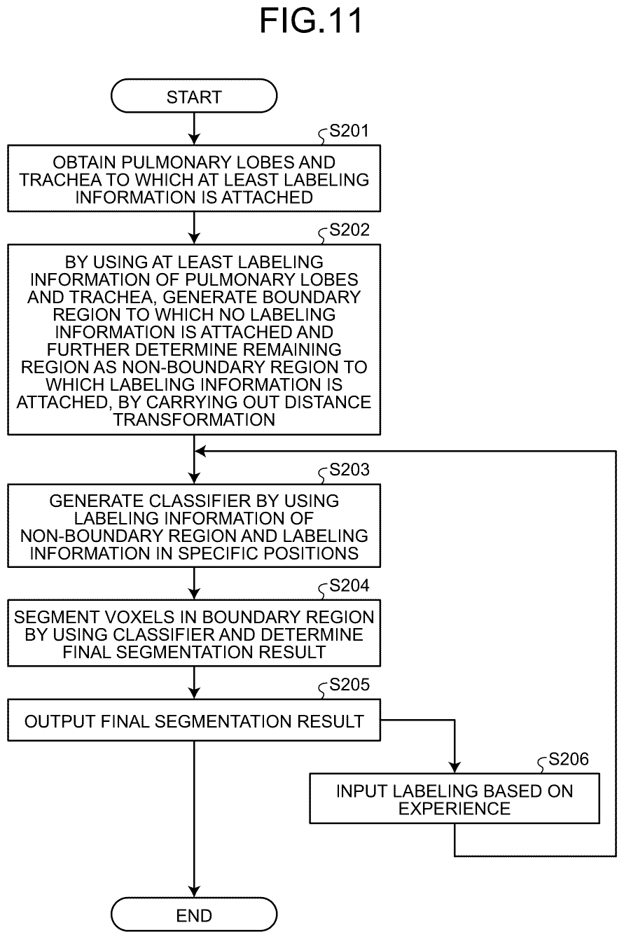

Next, the second embodiment will be explained with reference to FIG. 11. FIG. 11 is a flowchart illustrating the process (the image segmentation method) performed by the image segmentation apparatus 20 according to the second embodiment.

At step S201 in FIG. 11, the obtaining function 21 obtains the pulmonary lobes and the trachea to which at least the labeling information is attached. In this situation, at step S201, the experience labeling may also be obtained via the input interface 101, in addition to the pulmonary lobes and the trachea to which the labeling information is attached.

At step S202 in FIG. 11, by carrying out the distance transformation, the coarse segmentation function 22 generates the boundary region to which no labeling information is attached by using at least the labeling information of the pulmonary lobes and the trachea and further determines the remaining region as the non-boundary region to which the labeling information is attached. In addition, the experience labeling obtained at step S201 may be used at step S202.

At step S203 in FIG. 11, the classifier generating function 23 generates a classifier by using the labeling information of the non-boundary region and the labeling information in the specific positions. As explained above, the specific positions are the voxels in certain positions among which the differences in the distance to adjacently-positioned labeled regions are smaller than the threshold value and are therefore important for distinguishing the two adjacently-positioned labeled regions. Further, the experience labeling is the voxels in an important region that was added artificially. Thus, these two are substantially the same as each other. Consequently, the labeling information in the specific positions at step S203 further includes the experience labeling added artificially, in addition to the labeling information in the specific positions specified on the basis of the boundary region and the trachea.

At step S204 in FIG. 11, the fine segmentation function 24 segments the voxels in the boundary region by using the classifier and thus determines a final segmentation result. At step S205 in FIG. 11, the output function 25 outputs the obtained final segmentation result.

After the final segmentation result is output so as to be displayed on a display or the like at step S205, the image segmentation method according to the second embodiment further includes step S206 at which the user inputs the experience labeling via the input interface 101. Consequently, by using anew the experience labeling that has been input for generating a classifier, the image segmentation apparatus 20 according to the second embodiment is able to update the generated classifier and to determine and output a final segmentation result anew, by using the updated classifier (the hyperplanes).

As a result, it is possible to obtain the segmentation result illustrated in the bottom section of FIG. 12 in which the boundary is pasted with the vein.

By using the image segmentation apparatus 20 and the image segmentation method according to the second embodiment, in addition to the advantageous effects of the first embodiment, it is possible to conveniently correct the local segmentation result that did not fit expectation. It is therefore possible to save the user trouble of correcting the entirety and to enhance the precision level of the image segmentation.

### Other Embodiments

The constituent elements of the apparatuses illustrated in the drawings of the present embodiments are based on functional concepts. Thus, it is not necessarily required to physically configure the constituent elements as indicated in the drawings. In other words, specific modes of distribution and integration of the apparatuses are not limited to those illustrated in the drawings. It is acceptable to functionally or physically distribute or integrate all or a part of the apparatuses in any arbitrary units, depending on various loads and the status of use. Further, all or an arbitrary part of the processing functions performed by the apparatuses may be realized by a CPU and a program analyzed and executed by the CPU or may be realized as hardware using wired logic.

It is possible to realize the methods explained in the above embodiments, by causing a computer such as a personal computer or a workstation to execute a program prepared in advance. The program may be provided as being pre-loaded in a Read-Only Memory (ROM) or memory circuitry. Further, the program may be recorded on a non-transitory computer-readable recording medium such as a Compact Disc Read-Only Memory (CD-ROM), a Flexible Disk (FD), a Compact Disc Recordable (CD-R), or a Digital Versatile Disc (DVD), in a file in a format that is installable or executable by those apparatuses, so as to be executed as being read from the recording medium by a computer.

Further, it is also acceptable to have the program saved in a computer connected to a network such as the Internet, so as to be provided or distributed as being downloaded via the network.

According to at least one aspect of the embodiments described above, it is possible to obtain a smooth boundary segmentation result, in contrast to the situations where an image is segmented by using only a distance transformation. Further, in contrast to the method by which a user (an operator) labels feature points at the boundaries so as to carry out the curve fitting, it is possible to give the operator intuitive feelings. In addition, because it is possible to add the experience labeling at different stages, it is possible to conveniently achieve a segmentation result having a higher level of precision.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image segmentation apparatus comprising processing circuitry configured:
to obtain a massive region to which labeling information is attached and a tubular region to which labeling information is attached;
to generate, by using the labeling information of the massive region and the labeling information of the tubular region, a region to be segmented to which no labeling information is attached and which is a boundary region of substructures of the massive region and a non-boundary region serving as a coarse segmentation result to which labeling information is attached, by carrying out a distance transformation;
to generate a classifier for classifying spatial coordinates, by using the labeling information of the non-boundary region and labeling information in a specific position determined on a basis of the region to be segmented and the tubular region; and
to segment voxels in the region to be segmented by using the classifier and to thus determine a final segmentation result.

2. The image segmentation apparatus according to claim 1, wherein
the massive region obtained by the processing circuitry is a region that is anatomically able to cover the tubular region, and the massive region is divided into segments in a first quantity so that mutually-different pieces of labeling information are attached to the segments serving as independent labeled regions,
the tubular region obtained by the processing circuitry is divided into segments in a second quantity, so that mutually-different pieces of labeling information are attached to the segments serving as independent labeled regions, and
the non-boundary region generated by the processing circuitry is divided into segments in the second quantity, so that mutually-different pieces of labeling information are attached to the segments serving as independent labeled regions.

3. The image segmentation apparatus according to claim 1, wherein the processing circuitry is configured to generate the classifier, by uniformly sampling the non-boundary region with respect to each of mutually-different pieces of labeling information and using sampled voxels as a first input and further using, without sampling, the labeling information in the specific position determined on the basis of the region to be segmented and the tubular region to which the labeling information is attached as a second input.

4. The image segmentation apparatus according to claim 1, wherein the massive region is at least one pulmonary lobe, whereas the tubular region is either a trachea or a blood vessel.

5. The image segmentation apparatus according to claim 4, wherein, by carrying out a distance transformation, the non-boundary region is segmented into a plurality of labeled regions corresponding to branch structures of the tubular region.

6. The image segmentation apparatus according to claim 5, wherein, to the labeled regions in the tubular region and in the non-boundary region, corresponding labeling information is attached.

7. The image segmentation apparatus according to claim 1, wherein the processing circuitry is configured to output the final segmentation result.

8. The image segmentation apparatus according to claim 3, wherein the processing circuitry is configured to determine, as the region to be segmented, voxels among which differences in distance to two labeled regions that are mutually different and positioned adjacent to each other are smaller than a threshold value.

9. The image segmentation apparatus according to claim 1, wherein the specific position corresponds to all voxels in a certain part of the tubular region that overlaps with the region to be segmented.

10. The image segmentation apparatus according to claim 1, wherein the classifier is a hyperplane configured to classify voxels on a basis of spatial three-dimensional position information and labeling information.

11. The image segmentation apparatus according to claim 10, wherein
there are a plurality of hyperplanes including the hyperplane, and
with respect to each of the hyperplanes, voxels positioned on a mutually same side have a mutually same piece of labeling information, whereas voxels positioned on mutually-different sides have mutually-different pieces of labeling information.

12. The image segmentation apparatus according to claim 11, wherein, by using the hyperplanes, the processing circuitry is configured to determine labeling information of voxels in the region to be segmented, on a basis of the spatial three-dimensional position information of the voxels in the region to be segmented, and
the processing circuitry is configured to obtain the final segmentation result, by putting together the determined labeling information of the voxels in the region to be segmented, with the coarse segmentation result.

13. The image segmentation apparatus according to claim 1, wherein the processing circuitry is configured to prompt a user to add experience labeling.

14. The image segmentation apparatus according to claim 13, wherein, as the labeling information in the specific position, the added experience labeling is used for generating the classifier.

15. An image segmentation method comprising:
an obtaining step of obtaining a massive region to which labeling information is attached and a tubular region to which labeling information is attached;
a coarse segmentation step of generating, by using the labeling information of the massive region and the labeling information of the tubular region, a region to be segmented to which no labeling information is attached and which is a boundary region of substructures of the massive region and a non-boundary region serving as a coarse segmentation result to which labeling information is attached, by carrying out a distance transformation;
a classifier generating step of generating a classifier for classifying spatial coordinates, by using the labeling information of the non-boundary region and labeling information in a specific position determined on a basis of the region to be segmented and the tubular region; and
a fine segmentation step of segmenting voxels in the region to be segmented by using the classifier and thus determining a final segmentation result.

16. The image segmentation method according to claim 15, wherein, in the coarse segmentation step, by carrying out a distance transformation, voxels among which differences in distance to two labeled regions that are mutually different and positioned adjacent to each other are smaller than a threshold value are determined as the region to be segmented without attaching any labeling information thereto, whereas a remaining region excluding the boundary region is determined as the non-boundary region with which original labeling information is kept.

17. A non-transitory computer-readable recording medium having recorded thereon a program that causes a computer to execute:
an obtaining step of obtaining a massive region to which labeling information is attached and a tubular region to which labeling information is attached;
a coarse segmentation step of generating, by using the labeling information of the massive region and the labeling information of the tubular region, a region to be segmented to which no labeling information is attached and which is a boundary region of substructures of the massive region and a non-boundary region serving as a coarse segmentation result to which labeling information is attached, by carrying out a distance transformation;
a classifier generating step of generating a classifier for classifying spatial coordinates, by using the labeling information of the non-boundary region and labeling information in a specific position determined on a basis of the region to be segmented and the tubular region; and
a fine segmentation step of segmenting voxels in the region to be segmented by using the classifier and thus determining a final segmentation result.

18. The recording medium according to claim 17, wherein, in the coarse segmentation step, by carrying out a distance transformation, voxels among which differences in distance to two labeled regions that are mutually different and positioned adjacent to each other are smaller than a threshold value are determined as the region to be segmented without attaching any labeling information thereto, whereas a remaining region excluding the boundary region is determined as the non-boundary region with which original labeling information is kept.
